(19) United States
(12) Patent Application Publication
(10) Pub. No.: US 2017/0065921 A1
(43) Pub. Date: Mar. 9, 2017

(54) AIR PURIFIER

(71) Applicant: Yang Lo, Flushing, NY (US)

(72) Inventor: Yang Lo, Flushing, NY (US)

(21) Appl. No.: 14/844,136

(22) Filed: Sep. 3, 2015

(51) Int. Cl. B01D 46/44; B01D 46/00

(52) U.S. Cl. CPC B01D 46/442; B01D 46/0005; B01D 46/0024; B01D 46/0028; B01D 46/0045; B01D 46/008; B01D 2267/40; B01D 2279/65

(57) ABSTRACT

Disclosed is an air purifier apparatus for purifying air from pollutants. The air purifier apparatus includes a housing having a front side, a rear side, a top side and a bottom side; a back cover having meshes attached to the rear side of the housing; a front cover having meshes attached to the front side of the housing; a rectangular box having one or more frames configured within the housing and in between the back cover and the front cover; an inner rotor motor configured in at least one of the frame of the rectangular box near to the front cover; a backward centrifugal wind wheel configured in at least one of the frame of the rectangular box rotates to suck air through the back cover, wherein the inner rotor motor rotates the backward centrifugal wind wheel; one or more filters configured in between the back cover and the rectangular box to filter air from pollutants received through the back cover; wherein the rotation creates a vacuum in between at least one of the one or more filters and the centrifugal wind wheel, the vacuum results in sucking of the air through the back cover and further releases the purified air through the meshes of the front cover.

### BACKGROUND OF THE INVENTION

1. Field of the Invention

The present invention generally relates to air purifier and more particularly relates to air purifier that includes a backward centrifugal wind wheel and an inner rotor motor for preventing airflow loss and noise pollution.

2. Description of Related Art

Air quality is one of the most significant problems within homes and the workplace today. The modern environment is filled with impurities such as pollution and particulate matter, which makes its way into the air that occupies just about every structure. These impurities may include, among other things, molds, pollen, bacteria, dust, and viruses.

The spread of these particles can produce serious reactions among those who are sensitive. Even among those who are less-sensitive, long term exposure to contaminated air may cause respiratory or other health problems. Breathing cleaner air generally leads to improve health.

Several types of air purifiers have been developed that uses a HEPA filter to remove airborne irritants. Few air purifiers uses spiraled discharged scrolls that distribute air uniformly around the device. Few air purifiers use ultraviolet light to kill pathogens. All these air purifiers use the centrifugal fan that suck air from the front and exit from the top.

These air purifiers have high power consumption and needs a special air duct that result in high noise and the airflow loss. Therefore, there is a need of an air purifier that does not require an air duct and prevents airflow loss. Further, the air purifier prevents noise pollution and power consumption.

### SUMMARY OF THE INVENTION

In accordance with the teachings of the present invention, an air purifier apparatus for purifying air from pollutants is provided.

An object of the present invention is to provide a housing, a back cover having meshes attached to the rear side of the housing, a rear cover having meshes attached to the front side of the housing, a rectangular box having one or more frames configured within the housing and in between the back cover and the front cover, and an inner rotor motor configured in at least one of the frame of the rectangular box near to the front cover.

Further, the air purifier apparatus includes a backward centrifugal wind wheel configured in at least one of the frame of the rectangular box rotates to suck air through the back cover, wherein the inner rotor rotates the backward centrifugal wind wheel. Further, the air purifier apparatus includes one or more filters configured in between the back cover and the rectangular box to filter air through the back cover and further releases the purified air through the meshes of the front cover.

Further, the rotation creates a vacuum in between at least one of the one or more filters and the backward centrifugal wind wheel, the vacuum results in sucking of the air through the meshes of the back cover and further releases the purified air through the meshes of the front cover.

Another object of the present invention is to provide the air purifier apparatus including a motor mounting bracket for mounting the inner rotor motor in at least one of the frames of the rectangular box. Further, the air purifier apparatus including a motor holder for holding the inner rotor motor within the backward centrifugal wind wheel.

Another object of the present invention is to provide the air purifier apparatus including an air flow guide ring configured within the rectangular box for guiding the purified air through the backward centrifugal wind wheel. Further, the air purifier apparatus includes a power switch to receive power from a power supply and further passing the power to the motor.

Another object of the present invention is to provide the air purifier apparatus including a display unit for displaying the air quality, speed of inner rotor motor and inner rotor motor running time. Further, the air purifier apparatus includes a ultra-violet (UV) light sterilization assembly configured in between the one or more filters and the backward centrifugal wind wheel for providing pollutant free air.

Another object of the present invention is to provide the air purifier apparatus including a controller programmed for performing either the measurement of the rotation speed of the inner rotor, running time of the inner rotor motor or controls the speed of the inner rotor motor.

Another object of the present invention is to provide the air purifier apparatus one or more wheels for moving the box to any desired location. This is to make the air purifier apparatus portable. Further, the air purifier includes a particle sensor configured in the rectangular box to monitor the quality of air in the vicinity and further signals the controller to raise or lower fan speed depending on the amount of particles in the room.

Further features and advantages of the present invention, as well as the structure and operation of various embodiments of the present invention, are described in detail below with reference to the accompanying drawings.

### BRIEF DESCRIPTION OF DRAWINGS

FIG. 1 illustrates an exploded view of the air purifier apparatus in accordance with a preferred embodiment of the present invention;

FIG. 2 illustrates a side view of the rectangular box containing the backward centrifugal wind wheel, inner rotor motor, and one or more filters showing the air flow through arrows in accordance with a preferred embodiment of the present invention;

FIG. 3 illustrates a front view of the air purifier apparatus showing display screen and the power switch in accordance with a preferred embodiment of the present invention; and

FIG. 4 illustrates a rear view of the air purifier apparatus showing back cover with meshes in accordance with a preferred embodiment of the present invention.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF DRAWINGS

While this technology is illustrated and described in a preferred embodiment, an air purifier apparatus for purifying air from pollutants, may be produced in different sizes, shapes and colors. This is depicted in the drawings, and will herein be described in detail, as a preferred embodiment of the invention, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the technology described herein.

Reference will now be made in detail to several embodiments of the invention which are illustrated in the accompanying drawings. Wherever feasible and convenient, the same reference numerals are used in the figures and the description to refer to the same or like parts. The drawings are in a simplified form and not to precise scale. For purposes of convenience and clarity only, directional terms, such as top, bottom, left, right, up, down, over, above, below, beneath, rear, and front may be used with respect to the accompanying drawings. In addition, words such as attached, affixed, coupled, connected and similar terms with their inflectional morphemes are used interchangeably, unless the difference is noted or made otherwise clear from the context. These words and expressions do not necessarily signify direct connections, but include connections through mediate components and devices.

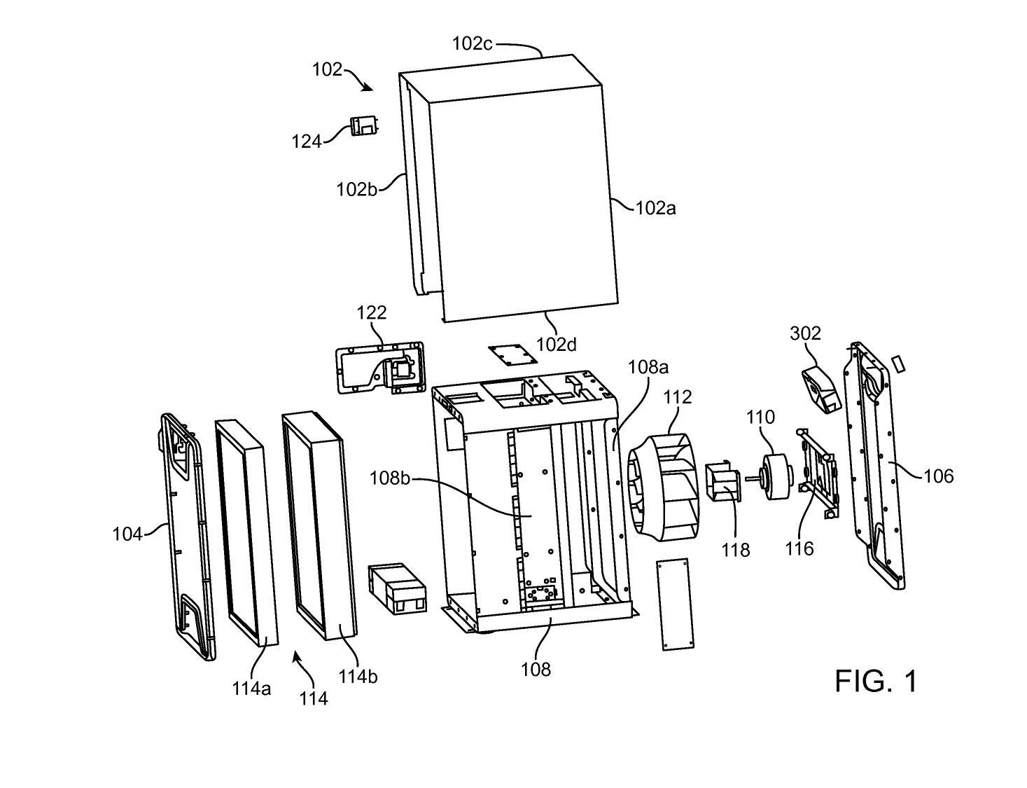

FIG. 1 illustrates an exploded view of the air purifier apparatus 100 in accordance with a preferred embodiment of the present invention. The air purifier apparatus 100 includes a housing 102 having a front side 102a, rear side 102b, a top side 102c and a bottom side 102d. The housing 102 is generally rectangular in shape. However, it would be readily apparent to those skilled in the art that various shapes of housing 102 may be envisioned without deviating from the scope of the present invention.

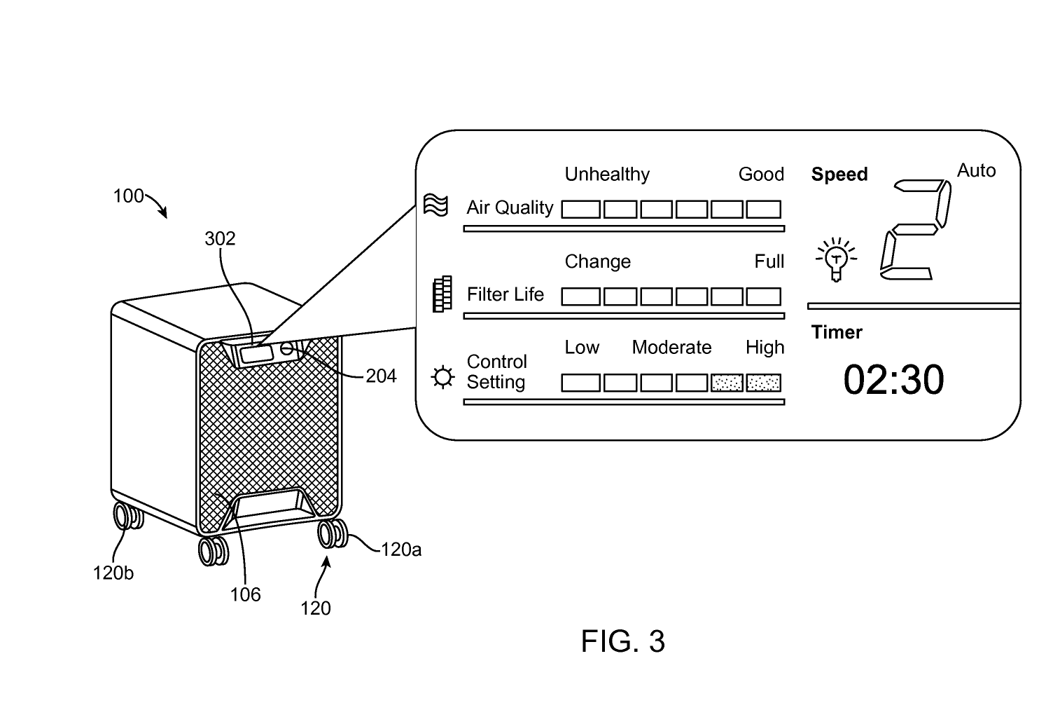

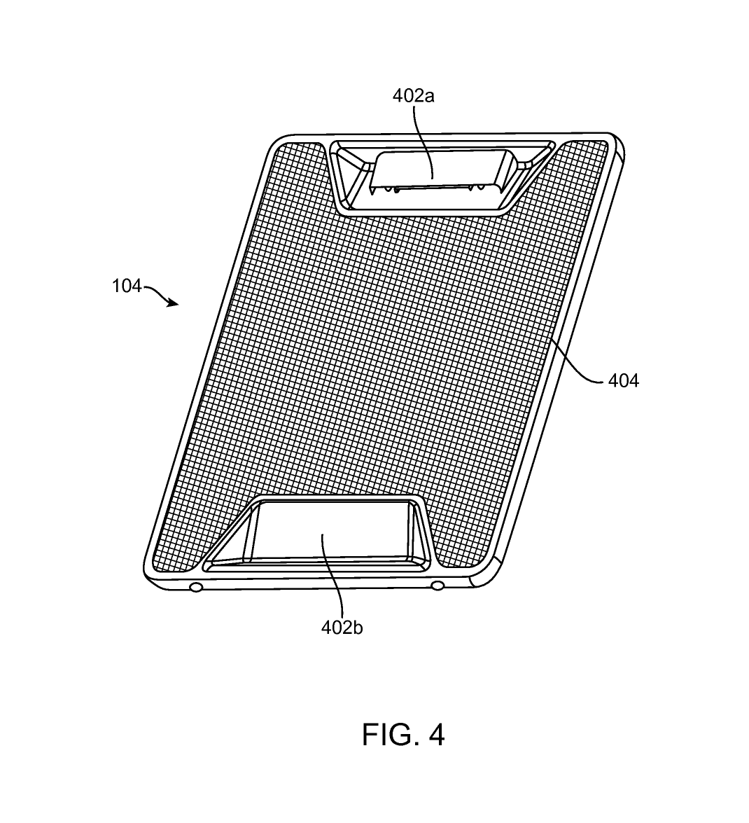

Further, the air purifier apparatus 100 includes a back cover 104 having meshes attached to the rear side 102b of the housing, a front cover 106 having meshes attached to the front side 102a of the housing. The front cover 106 and the back cover 104 with meshes is explained in detail in conjunction with FIG. 3 and FIG. 4 respectively of the present invention.

Further, the air purifier apparatus includes a rectangular box 108 having one or more frames 108a and 108b configured within the housing 102 and in between the back cover 104 and the front cover 106, an inner rotor motor 110 configured in the frame 108a of the rectangular box 108 near to the front cover 106.

In a preferred embodiment of the present invention, the inner rotor motor 110 is an inner rotor axial flow motor such as a capacitor motor, a hood pole motor, a brushless DC motor, a brushed DC motor, single phase asynchronous motor, and a three-phase asynchronous motor. However, it would be readily apparent to those skilled in the art that various inner rotor motor 110 may be used without deviating from the scope of the present invention.

The air purifier apparatus 100 further includes a backward centrifugal wind wheel 112 configured in the frame 108b of the rectangular box 108 rotates to suck air through the back cover 104. Further, the inner rotor motor 110 rotates the backward centrifugal wind wheel 112.

In a preferred embodiment of the present invention, the backward centrifugal wind wheel 112 is having outlet blade angle less than 90 degree. However, it would be readily apparent to those skilled in the art that various types of backward wind wheel 112 may be envisioned without deviating from the scope of the present invention.

The air purifier apparatus 100 further includes one or more filters 114 such as 114a and 114b configured in between the back cover 104 and the rectangular box 108 to filter air from pollutants received through the meshes of the back cover 104. In a preferred embodiment of the present invention, the filter 114a is a High Efficiency Particulate Air (HEPA) filter and the filter 114b is either a carbon filter or antibacterial filter. However, it would readily apparent to those skilled in the art that various forms of filters 114 may be used without deviating from the scope of the present invention.

In a preferred embodiment of the present invention, rotation creates a vacuum is created in between the filter 114b and the backward centrifugal wind wheel 112. The vacuum results in sucking of the air through the meshes of the back cover 104 and further releases the purified air through the meshes of the front cover 106.

In another preferred embodiment of the present invention, the air purifier apparatus 100 further includes a motor mounting bracket 116 for mounting the inner rotor motor 110 on the frame 108a of the rectangular box. In a preferred embodiment, the motor mounting bracket 116 is rectangular in shape. However, it would be readily apparent to those skilled in the art various shapes of the motor mounting bracket 116 may be envisioned without deviating from the scope of the present invention.

In another preferred embodiment of the present invention, the air purifier apparatus 100 further includes a motor holder 118 for holding the inner rotor motor 110 onto the motor mounting bracket 116. The backward centrifugal wind wheel 112 is mounted onto the shaft of motor 110 and fastened by a nut securely.

In another preferred embodiment of the present invention, the air purifier apparatus 100 further includes a particle sensor 122 configured in the rectangular box 108 to monitor the quality of the air in the vicinity. The particle sensor 122 is based on the principle of light scattering method and detects airborne particles.

Further, the air purifier apparatus 100 includes a particle sensor cover 124 attached to the rectangular box 108 provides covering to the particle sensor 122. The particle sensor cover 124 is to protect the particle sensor 122 for the wear and tear. It will be readily apparent to those skilled in the art that various shapes of the particle sensor cover 124 may be envisioned without deviating from the scope of the present invention.

Further, the air purifier apparatus 100 includes a display screen 302. The display screen 302 is explained in detail in conjunction with FIG. 3 of the present invention. Further, the air purifier apparatus 100 includes a controller (not shown in Figures) programmed for performing either the measurement of the rotation speed of the inner rotor motor 110, running time of the inner rotor motor 110 or controls the speed of the inner rotor motor 110.

The controller (not shown in Figures) is a micro-controller that is programmed to calculate the filter life from the inner rotor motor running time and speed of the inner rotor motor. The data determined by the controller (not shown in Figures) is displayed on the display screen 302 and is shown and explained in detail in conjunction with FIG. 3 of the present invention.

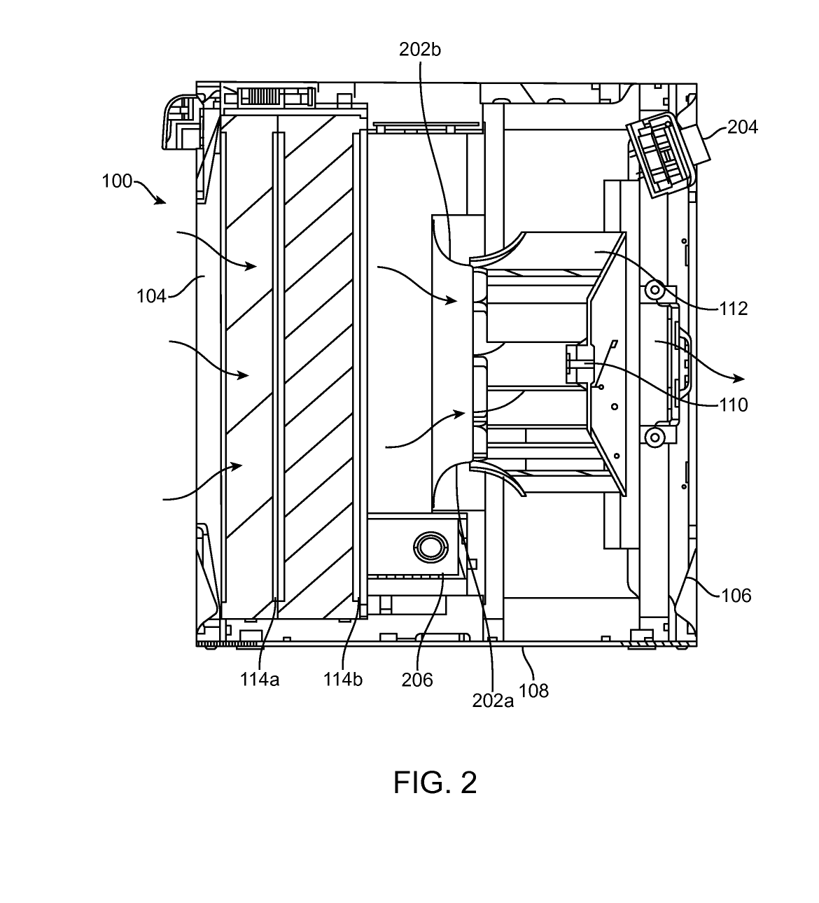

FIG. 2 illustrates a side view of the rectangular box 108 containing the backward centrifugal wind wheel 112, inner rotor motor 110, and the filters 114a and 114b showing the air flow through arrows in accordance with a preferred embodiment of the present invention. The air purifier apparatus 100 further includes air flow guide ring 202a, 202b configured within the rectangular box 108 for guiding the purified air through the backward centrifugal wind wheel 112.

The arrows show the flow of the air through the meshes of the back cover 104 and thereafter getting purified through the filters 114a and 114b, then the purified air further moves through the backward centrifugal wind wheel 112 via the air flow guide ring 202a and 202b; and finally the purified air moves out of the meshes of the front cover 106.

Further, the air purifier apparatus 100 includes a power switch 204 configured on the front cover 106 to receive power from a power supply and further passing the power to the inner rotor motor 110. The power switch 204 is explained in detail in conjunction with FIG. 3 of the present invention.

Further, the air purifier apparatus 100 includes a ultra-violet (UV) light sterilization assembly 206 configured in between the filter 114b and the backward centrifugal wind wheel 112 for providing bacteria free air. The UV light sterilization assembly 206 removes bacteria from the air.

FIG. 3 illustrates a front view of the air purifier apparatus 300 in accordance with a preferred embodiment of the present invention. The front cover 106 is shown with the meshes that releases the air received from the inner rotor motor (not shown in FIG. 3). The meshes are further explained in detail in conjunction with FIG. 4 of the present invention.

With reference to FIG. 1, the display screen 302 displays Air Quality, Filter Life, speed of the inner rotor motor (Speed), running time of the inner rotor motor (Timer) and the status of the UV light sterilization assembly. Further, the display screen 302 is a touch screen that also displays the control settings that allow the user to control the speed of the inner rotor motor. In a preferred embodiment of the present invention, the user is provided with three options i.e. Low mode, Moderate mode and High mode to operate the inner rotor motor.

Further, the power switch 204 configured on the front cover 106 receives power from a power supply and further transfer the power to the inner rotor motor (not shown in FIG. 3). The power supply could be a battery or through AC supply. Examples of the power switch 204 include but not limited to button switch, rotary switch, or a sound control switch. The power switch 204 may further be used to supply power to the display screen 302. The power switch 204 may further to be used to adjust the speed of backward centrifugal wind wheel manually in either anticlockwise or clockwise direction.

Further, the display screen 302 includes LED lights that blink for indicating the level of the air quality i.e. unhealthy or good and further blinks to indicate the status of the filter i.e. change or full. The LED lights may act as a reminder to change or wash the filter and further to let the user know about the quality of air they are living in.

In another preferred embodiment of the present invention, the air purifier apparatus 100 further includes one or more wheels 120 such as 120a and 120b for moving the box 108. The one or more wheels 120 make the housing 102 portable and could be moved to any location as per the requirement of the user.

In another preferred embodiment of the present invention, the air purifier 100 further includes an interlock switch (not shown in Figures) configured on the top side and the bottom side of the housing to shut off the power when at least one of the one or more filters; and the ultra-violet light sterilization assembly is replaced, and further when the rear cover is removed. The inter-lock switch (not shown in Figures) is to maintain the safety of the users while servicing the components of the air purifier.

FIG. 4 illustrates a rear view of the air purifier apparatus 100 in accordance a preferred embodiment of the present invention. The air purifier apparatus 100 further includes handles 402a, 402b for opening and closing of the rear cover 104. It would be readily apparent to those skilled in the art that various shapes of handles 402a and 402b may be envisioned without deviating from the scope of the present invention.

Further, the rear cover 104 includes meshes 404 for receiving the air from the environment. Similar meshes are used in the front cover (not shown in FIG. 4). Examples of the meshes 404 include but not limited to metal meshes, stainless steel meshes, plastic meshes etc.

There has thus been shown and described an air purifier. Many changes, modifications, variations and other uses and applications of the subject invention will, however, become apparent to those skilled in the art after considering this specification and the accompanying drawings which disclose the preferred embodiments thereof. All such changes, modifications, variations and other uses and applications which do not depart from the spirit and scope of the invention are deemed to be covered by the invention, which is to be limited only by the claims which follow.

1. An air purifier apparatus for purifying air from pollutants comprising:
a housing having a front side, a rear side, a top side and a bottom side;
a back cover having meshes attached to the rear side of the housing;
a front cover having meshes attached to the front side of the housing;
a rectangular box having one or more frames configured within the housing and in between the back cover and the front cover;
an inner rotor motor configured in at least one of the frame of the rectangular box near to the front cover;
a backward centrifugal wind wheel configured in at least one of the frame of the rectangular box rotates to suck air through the back cover, wherein the inner rotor motor rotates the backward centrifugal wind wheel; and
one or more filters configured in between the back cover and the rectangular box to filter air from pollutants received through the meshes of the back cover;
wherein the rotation creates a vacuum in between at least one of the one or more filters and the backward centrifugal wind wheel, the vacuum results in sucking of the air through the meshes of the back cover and further releases the purified air through the meshes of the front cover.

2. The air purifier apparatus according to claim 1 further comprising a motor mounting bracket for mounting the inner rotor motor in at least one of the frames of the rectangular box.

3. The air purifier apparatus according to claim 1 further comprising a motor holder for holding the inner rotor motor onto the motor mounting bracket.

4. The air purifier apparatus according to claim 1 further comprising air flow guide ring configured within the rectangular box for guiding the purified air through the backward centrifugal wind wheel.

5. The air purifier apparatus according to claim 1 further comprising a power/speed switch configured on the front cover to receive power from a power supply and further passing the power to the inner rotor motor.

6. The air purifier apparatus according to claim 1 further comprising a particle sensor configured in the rectangular box to monitor the quality of air in the vicinity and further releases a signal.

7. 7. The air purifier apparatus according to claim 1 further comprising a particle sensor cover attached to the rectangular box provides covering to the particle sensor.

8. The air purifier apparatus according to claim 6 further comprising a controller programmed for at least one of the measuring the rotation speed of the inner rotor motor; inner rotor motor running time; and controlling the speed of the inner rotor motor on receiving signal from the particle sensor.

9. The air purifier apparatus according to claim 1 further comprising a ultra-violet (UV) light sterilization assembly configured in between at least one of the one or more filters and the backward centrifugal wind wheel for providing pollutant free air.

10. The air purifier apparatus according to claim 8 further comprising a display unit configured on the first cover for displaying at least one of the air quality; speed of the inner rotor motor; inner rotor motor running time; and information from the UV light sterilization assembly.

11. The air purifier apparatus according to claim 1 further comprising one or more wheels for moving the housing.

12. The air purifier apparatus according to claim 1 further comprising an interlock switch configured on the top side and the bottom side of the housing to shut off the power when at least one of the one or more filters; and the ultra-violet light sterilization assembly is replaced, and further when the rear cover is removed.
